(19) United States
(12) Patent Application Publication
(10) Pub. No.: US 2008/0245819 A1
(43) Pub. Date: Oct. 9, 2008

(54) Home device for flavors and essences

(76) Inventor: Giglia M. Galarce, Loveland, OH (US)

Correspondence Address: Giglia M. Galarce, 1346 Cross Creck Dr., Loveland, OH, 45140, US

(21) Appl. No.: 11/784,583

(22) Filed: Apr. 9, 2007

(51) Int. Cl. B67D 5/56; B67D 5/06

(52) U.S. Cl. 222/129; 222/179.5; 222/180

(57) ABSTRACT

The home device for flavors and essences is an economical and very simple method for dispensing a variety of concentrated liquid flavors and essences.

The device combines a holder and a set of small or medium size container bottles with dropper ends That will allow the preparation of flavored waters, the enhancement of common drinks, desserts, yogurt and other food in an economical and attractive way. It could be conveniently placed or installed on or inside any refrigerator, cabinet, wall surface or other, making it very handy and easy to use. The device could also be used by the cosmetic industry and as a display method and sampling tool.

I, Giglia Maria Galarce, have invented a device for concentrated flavors and essences in a liquid form that enables people to enhance the water from their refrigerators with a variety of flavors in an easy and economical way in the comfort of their own kitchen. The device can also be used with other flavors in the enhancement and preparation of different beverages, food, and other recipes.

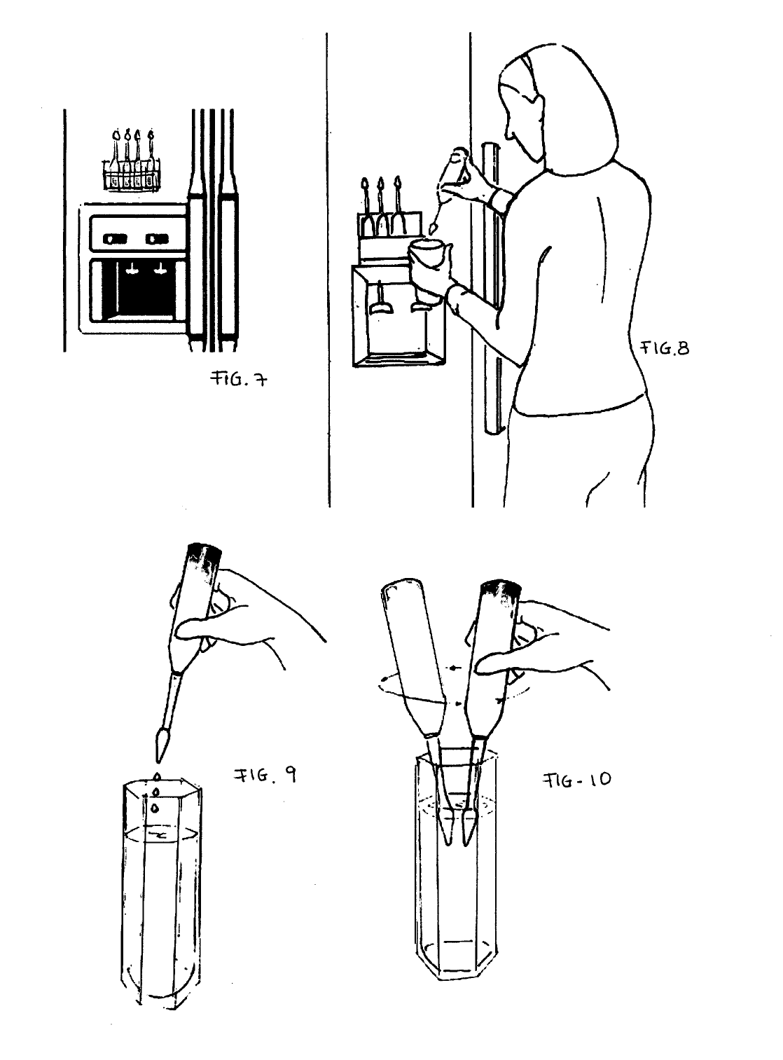

I have done thorough research into the flavoring market, and I have yet to find a similar product with the same attributes of the product that I have envisioned. My product assembles a practical holder and a set of small plastic bottles with long neck dropper ends, as shown in FIG. 5. These dropper bottles are disposable but they could also be refilled if wanted. It is a very practical and attractive way to introduce a variety of concentrated flavors in liquid form in supermarkets, wholesale retailers, and general stores. The device is not only a new concept for the food market, but could also be use to sale essences and aromas to prepare cosmetic recipes at home.

### Market Research

In my research I have found flavorings and syrups, but mostly in larger containers, these flavorings are generally used in commercial establishments such as bars, ice cream parlors, snow cone carts, and most commonly, in coffee shops. Smaller bottles of liquid flavors also exist, but these are sold individually, and in more traditional shaped bottles with different types of dropper systems and are sold mostly in the internet and specialty stores and they are not for water. Supermarkets offer flavored water but it is already made and costly, and the flavorings they sell are sold individually in the pastry products section, these flavors are not to enhance water and other drinks. There are many other products meant for the enhancement of water, but are only to prepare drinks such as iced tea, juices, lemonades, kool-aid etc; most of these products come powder or syrup form. There are no products in grocery stores for the preparation of flavored waters in one's home.

### BACKGROUND OF THE INVENTION

The main idea of the water flavoring kit came to me from a personal need. Like many other people, I don't like the taste of plain water from the fridge; therefore, I have been consuming substitute drinks for many years: adding extra calories, caffeine, sodium, colorants, preservatives, and other unhealthy additives common in most beverages, to my daily diet. Not only are these substitutes not very healthy but they also cost money, unlike water from one's tap or refrigerator.

Having studied graphic design and having experience with marketing and advertising, I started to design the idea I had in mind, not only for my own use, but also to help others with the same dilemma.

I later noticed there was also a need for flavorings in coffee, tea, and other products. I believe my idea could be a great solution to the over consumption of soft drinks and other sugary beverages, and in a convenient form that will serve as a positive addition to most family homes.

### How Is It and How Does It Works?

I designed my device thinking mostly in the enhancement of water, and it is meant to be conveniently placed on the front of the refrigerator door using a magnet sheet, as shown in FIG. 3-B. For other types of surfaces, a double faced adhesive or other installing system could be used. The holder could also be placed in different manners: on a wall, inside the refrigerator, inside or under a cabinet, or simply be laid on a counter top. The aesthetic of the containers and the holder could vary when applied to different beverages such as coffee, tea, cocktails, and yogurt, or when applied to cooking and other recipes as FIGS. 11 to 19 will show.

Holder and containers could be built in different styles, materials, colors, sizes, and shapes. But basically the bottles will be small in size, will have dropper caps inserted, and will be made of soft polyethylene to allow bottles to be squeezed and a number of drops to be poured into the substance as shown in FIG. 9.

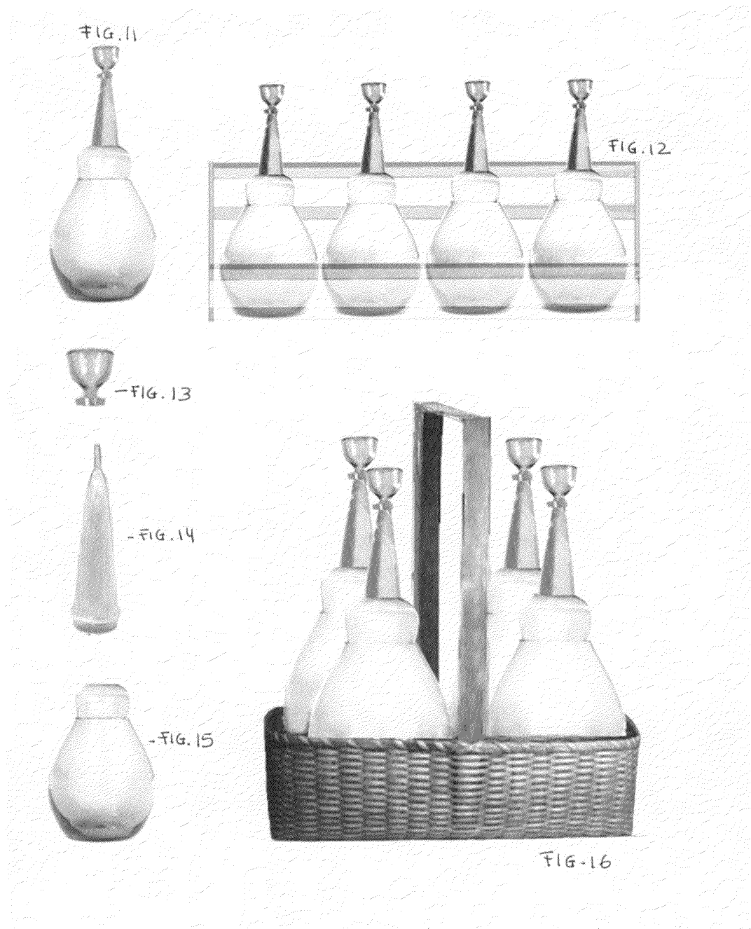

For the basic design which is meant for water, which will be for the refrigerator, the operation for making flavored water is very simple. Once the holder with the dropper bottles is properly installed, FIG. 7. The user only has to serve him/herself a glass of water from the water dispenser in the fridge or a water filter, and then pick up a small bottle containing the flavor of choice, FIG. 8. The user would then turn it over the glass and gently squeeze a number of drops (The number of drops will be established by the flavor producer.) as shown in FIG. 9. Then the user will stir in the flavor into the water using the long neck of the same bottle specifically designed for that purpose. See FIG. 10

### OBJECTS AND ADVANTAGES

The device as a Water Enhancer Kit could help benefit general health. It is well known drinking a good quantity of water is essential to a good health. People, who currently avoid water because they don't like the taste of it, will start having a more positive feeling about water.

There is also an environmental benefit, because even though the small container bottles will be made of plastic, the concentrated flavors will allow people to use the water from their own refrigerator, and the industry would have to produce less plastic containers, lowering the production of non-biodegradable waste which is a contributing factor to our planet's contamination.

Certain people are now forcing themselves to drink a good quantity of water for health purposes, and many might find that drinking flavored water might be easier and more enjoyable.

People currently buying flavored water will have the possibility to save some money and prepare it at home.

Families will find my idea a healthy way to start drinking more water and also save money from their expenses in soft drinks and other beverages.

Seniors, pregnant women, and people with back problems will benefit because it is much easier to carry the flavor kits home from the store than it is to carry bottles and cans with drinks.

People will find using the drinks enhancement kit can save them space for storage in their pantry and kitchen cabinets.

My invention will offer the flavoring industry a new way to sell their product.

I believe business offices and retail stores will find the water and coffee enhancer kits a friendly and nice addition to the table where creamer, sugar, regular coffee and mineral water are usually offered to their clients and employees.

The device will offer new options to people giving them the chance to buy flavors and to use for themselves, in an easy and economical way, a variety of products that otherwise would have to be purchased separately. For example a person who now buys a variety of flavored coffees, would only have to buy regular coffee and a kit with flavors for coffee.

### ALTERNATIVE VARIATIONS OF THE INVENTION

Other variations of the invention are possible. Changing the dropper systems, for example: to a flip top dispensing cap, or a pump, a plastic pipette, a manual dispenser syringe, and could be also an automatic or more modern electronic system with buttons that could be installed on the refrigerator door or a system already installed in the refrigerator door for the purpose of flavoring the water.

### Other Ways My Invention Could Be Use

Other than the Water Enhancer Kit, there could be Kits with flavors for the specific use in coffee that will enable any one to prepare a gourmet coffee at home.

The Spices Industry could use my device to incorporate to the market, spices in a liquid form.

There could be specific Kits to enhance wine.

There could be Kits specifically design for restaurant that want to add the coffee or water flavors to their tables for the use of their clients.

There could be specific flavor kits for tea.

The device could be use to contain and sale a variety of aromas for the Aroma Therapy.

The device could also be use by specialized baby food industry, for example: containing a variety of flavors to enhance baby's water or milk or with different aromas and essences to add to the baby's bath.

There could be also Kits with essences that could be use at home, in the preparation of homemade beauty masks, hair conditioners, etc

Also the cosmetic business and beauty salons might find this device useful for their products.

### ILLUSTRATION OF THE INVENTION AND IT'S USE

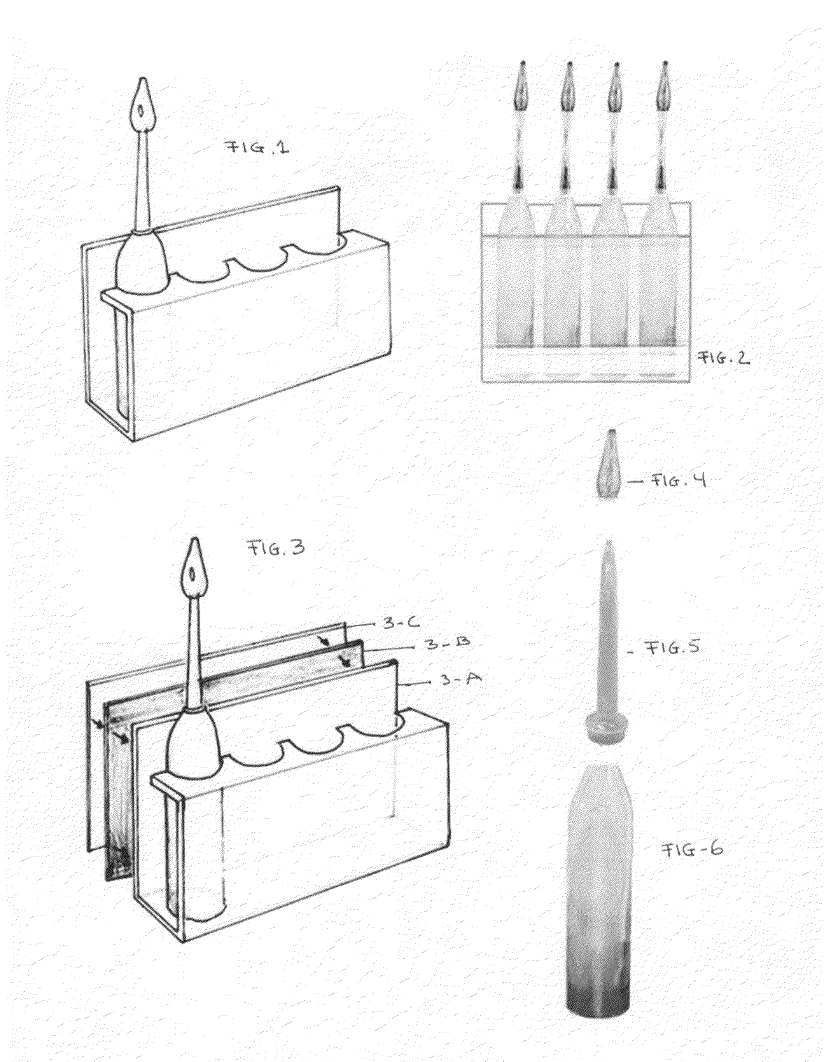

I have included some illustrations that help to see my invention and shows how can be use. FIGS. 1 to 10 refers basically to the Water Enhancer Kit and the basic idea of this product. FIGS. 11 to 19 will show how the device could be different and be used in different matters for a variety of flavors and essences.

FIG. 1: Shows a clear acrylic shelf with one of the containers.

FIG. 2: Shows the front view of the device in this case, with four containers ( the number of containers could vary).

FIG. 3: (3-A) Shows the acrylic holder shelf (3-B) shows the magnet sheet glued to the back of the holder. (3-C) shows a piece of felt that will be covering the magnet sheet and will be in between the magnet and the refrigerator surface, to protect the surface door from scratches.

FIG. 4: Shows a drop shaped piece made of high density polyethylene, that will be attached to the top open end of the tubular dropper neck and that will be use to help stir the drops in the drink.

FIG. 5: Shows the high density polyethylene tubular dropper neck that will be attached to the container bottle.

FIG. 6: Shows the container, made of soft polyethylene allowing the bottle to be squeezed.

FIG. 7: Shows how the clear shelf could be place onto the front of the refrigerator door.

FIG. 8: Shows how the device in use.

FIG. 9: Shows how the container is being use, by softly being squeeze.

FIG. 10: Shows how can the container's drop shape neck end is used to stir the water in the glass after adding the drops.

FIG. 11: Shows an example of a dropper bottle design in another shape

FIG. 12: Shows an example of the front view of the device as a kit with another design of holder to be place on a wall.

FIG. 13: Shows an example of a cap to be used when a seal is needed

FIG. 14: Shows an example of a different shaped neck when a seal is needed.

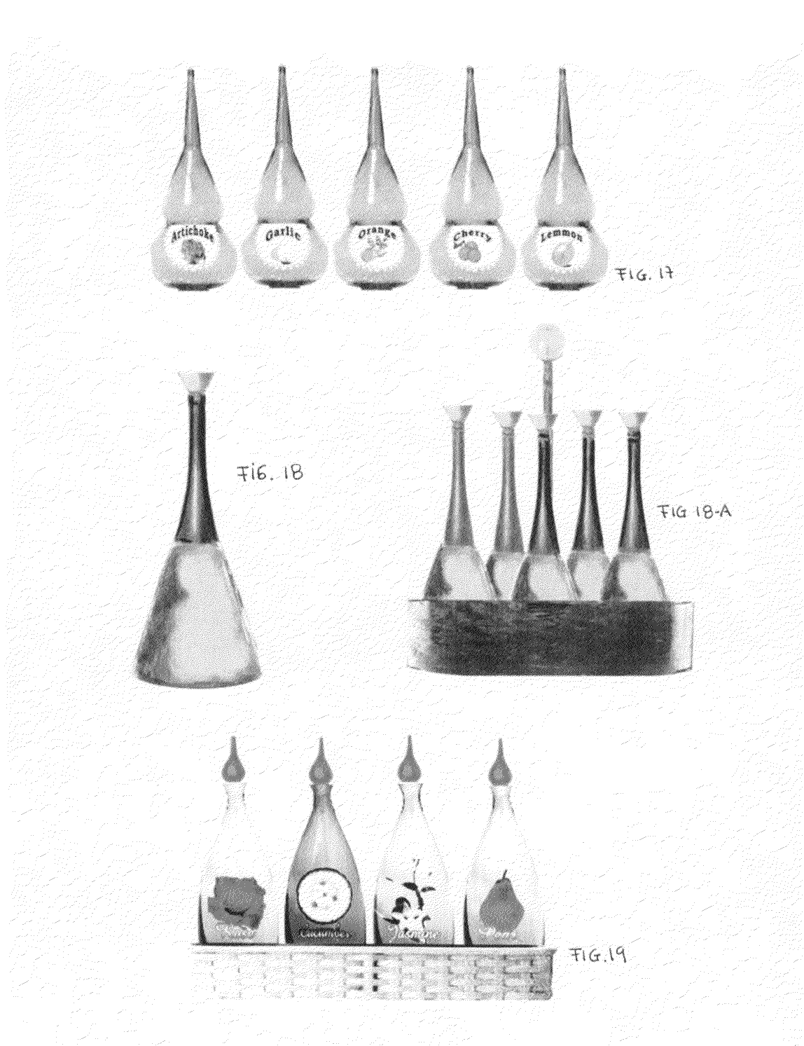

FIG. 15: Shows an example of a different shape of container, with an opening where the container could be refilled.

FIG. 16: Shows the device again as a Kit, with a different holder made of another material, and that could be placed on different surfaces, as this could be place on a counter top or a table.

FIG. 17: Shows an example of how the dropper bottles could be design in different shapes for different purposes, this set of five dropper bottles could be used for flavoring for cooking and spices in liquid form, these bottles are shown without caps, but caps could be added when needed.

FIG. 18: Shows another model of dropper bottles and holder as a kit, this time with a cap that protects the open end of the droppers.

FIG. 18: (18-A): Shows another way in which the holder could be design and be used, this one to be place on a counter top or a table, and the bottle droppers could contain flavors to be use in a home bar.

FIG. 19: Shows another example using the device, this time the holder and dropper bottles are designed to be used for essences in the cosmetic business.

I claim:

1. My claiming is on a device specifically intended for the use of dispensing flavors and essences in a liquid form comprising: A holder or shelving unit designed specifically to be attached or installed in any suitable manner to any surface, by using magnet sheets, metal screws, or any other appropriate installing method, a holder unit holding and containing a set of two or more dispenser dropper bottles, that could utilize any dropper system available and suitable to the density and any particular characteristic of the substance to dispense. Holder and containers could be built in different styles, materials, colors,sizes, and shapes, but basically the dispensers are intended to be small/medium in size, made of soft polyethylene or other that will allow for the bottles to be gently squeezed. The dispensers have been sought to be mainly disposable, but there could also be a non disposable model designed to be refilled or allowing just for the empty container section to be replaced with one refilled.

2. A device as claimed in claim 1. Specially designed to dispense concentrated liquid flavors for the enhancement of water and others. To be conveniently placed or installed on the outside FIG. 3-A or in the interior of any refrigerator. In this particular case of the device for refrigerators, the device could be an individual holder and carry just one individual dispenser as shown in FIG. 2-A

3. A device as claimed in claim number 1 and 2. Device in which a particular holder's design offers a choice for being easily removed, replaced, and conveniently transferred to a counter top, table or other as illustrated in FIGS. 9, 10 and 10-C.

4. A device as claimed in number 1 and 2, specially designed to be placed or installed out or inside any refrigerator, with variations due to an innovative esthetic design, any new dropper system or improved technology offered.

5. A device as claimed in claim 1 and 3 specially designed to dispense flavorings to regular coffee at home but could also be used in coffee shops, offices and other commercial establishments, see FIGS. 8 and 10-A

6. A device as claimed in claim 1 and 3, specially designed to dispense concentrated spices and essences in a liquid form for the use in food preparation. Samples of a set of dispenser for this device is illustrated in FIG. 11.

7. A device as claimed in claim 1 and 3, specially designed to be used in the baby's food industry to dispense concentrated flavors for the enhancement of baby water, drinks, food or medicines, and for other baby products such as essences for the bath, fragrances, oils, creams etc, see FIG. 13

8. A device as claimed in claim 1 and 3, specially designed to dispense liquid flavors for yogurt and desserts.

9. A device as claimed in claim 1 and 3, specially designed to dispense flavorings to regular tea, chamomile and other herbal drinks.

10. A device as claimed in claim 1 and 3, specially designed to dispense essences, oils, aromas and other for the cosmetic and perfume industry. It could be used to sale different natural products for the making of home cosmetics and to be conveniently placed or installed on any wall or inside or outside a cabinet.

11. A device as claimed in claim 1 and 3, specially designed to be used as a display method and a sampling tool to a variety of food products such as flavors, sauces, dressings, syrups, creams etc and with cosmetic products, such as creams, colognes, oils, perfumes etc. This device could be used in retailing stores, conventions, product demonstrations etc. See FIG. 12.
